(19) United States
(12) Patent Application Publication
(10) Pub. No.: US 2026/0162110 A1
(43) Pub. Date: Jun. 11, 2026

(54) METHODS AND SYSTEMS FOR UNIVERSAL IDENTITY VERIFICATION FOR FIDO PASSKEY REGISTRATION

(71) Applicant: Capital One Services, LLC, McLean, VA (US)

(72) Inventors: Kevin Osborn, Newton Highlands, MA (US); Narmeen Rahman, New York, NY (US); John Jones, Leesburg, VA (US)

(73) Assignee: Capital One Services, LLC, McLean, VA (US)

(21) Appl. No.: 18/969,896

(22) Filed: Dec. 5, 2024

(51) Int. Cl. G06Q 20/40; G06Q 20/32; G06Q 20/34; G06Q 20/38; H04L 9/08

(52) U.S. Cl. CPC G06Q 20/4014; G06Q 20/3276; G06Q 20/3278; G06Q 20/352; G06Q 20/3829; H04L 9/0819

(57) ABSTRACT

Described herein are methods and systems for universal identity verification for FIDO key registration. Some embodiments include receiving, at a server associated with a website, a request from a user account to register, with the website, a FIDO key associated with the user account. In response to receiving the request, causing, by the server, a program on a device associated with the user account to be initiated, the program to permit the device to receive encrypted data from a contactless card associated with the user account and to send the encrypted data to an authentication server to validate an identity of the user account. In response to receiving a first message indicating that the identity of the user account that sent the request has been validated, granting the request from the user account and registering the FIDO key associated with the user account with the website.

### FIELD OF THE DISCLOSURE

The present disclosure is generally related to Fast Identity Online (FIDO) authentication systems. More specifically, the present disclosure relates to implementations for universal identity verification for FIDO passkey registration.

### BACKGROUND

Public key challenge authentication protocols, such as FIDO2 by the FIDO Alliance and/or passkeys, are reliable in producing unforgeable authentications that may be facilitated using security keys stored on a user device. The security keys are randomly generated and used in a FIDO authentication process to sign a FIDO challenge when accessing an online resource using FIDO-based security. However, during the registration stage of FIDO2, registration and verification of the user's identity is critical because if a bad actor convinces the relying party site that the bad actor is Person A, the credential the bad actor creates can be used to act as Person A from then on, even as a first factor.

In FIDO-based systems, a user will register with the authentication system (e.g., via a website) to log into their account. The user will not need to remember a password because the FIDO framework requires the user device creating the account to have a FIDO private key as well as a FIDO public key associated therewith. During the FIDO registration process, the authentication system will create an account for the new user device being registered and associate the FIDO public key from the user device with the user account being registered. However, additional security features are needed to help prevent a bad actor from acting as another person to register a FIDO account in the other person's name and other credentials.

These and other deficiencies exist. As such, there is need for an improved system and process for a universal mechanism for requesting a specific second factor and optionally, matching other identifying information during the FIDO registration process.

### BRIEF SUMMARY

In one aspect, the present disclosure includes a method for universal identity verification for FIDO (e.g., FIDO2) key (e.g., FIDO passkey) registration is disclosed. In some embodiments, the method includes receiving, at a server associated with a website, a request from a user account to register, with the website, a Fast Identity Online (FIDO) key associated with the user account. The method further includes, in response to receiving the request, causing, by the server, a program on a device associated with the user account to be initiated, the program to permit the device to receive encrypted data from a contactless card associated with the user account and to send the encrypted data to an authentication server to validate an identity of the user account. In response to receiving, by the server associated with the website from the authentication server, a first message indicating that the identity of the user account that sent the request has been validated, the method includes granting the request from the user account and registering the FIDO key associated with the user account with the website.

In another aspect, another method for universal identity verification for FIDO key registration is disclosed. The method includes receiving, at a server associated with a website, a request from a user account to register, with the website, a Fast Identity Online (FIDO) key associated with the user account, the request including a selected second factor authentication mode and a user identifier associated with the user account. In response to receiving the request, the method includes sending a prompt to a mobile device associated with the user account and the user identifier, the prompt including a prompt to perform second factor authentication of the user account with an authentication server, where performing the second factor authentication of the user account includes using a contactless card associated with the user account in a manner corresponding to the selected second factor authentication mode. In response to receiving, by the server associated with the website from the authentication server, a first message indicating that an identity of the user account that sent the request has been authenticated, the method further includes granting the request from the user account and registering the FIDO key associated with the user account with the website.

In another aspect, an apparatus for universal identity verification for FIDO key registration is disclosed. The apparatus is associated with a website and includes a memory storing executable instructions thereon. The apparatus also includes a processing circuit to execute the executable instructions, which when executed by the processing circuit, causes the apparatus to receive a request from a computing device associated with a user account to register, with the website, a Fast Identity Online (FIDO) key associated with the user account. In response to receiving the request, the apparatus is further caused to send the computing device a message including an element for display on a web browser of the computing device, the element to be interacted with by a user of the computing device, where upon interacting with the element, a software application on a mobile device of a user associated with the user account is executed, wherein the software application is to permit the mobile device of the user to receive encrypted data from a contactless card associated with the user account and to send the encrypted data to an authentication server to validate an identity of the user account. In response to receiving, from the authentication server, an authentication response indicating that the identity of the user account associated with the mobile device has been validated, the apparatus is further caused to grant the request from the computing device and register the FIDO key associated with the user account with the website.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 is a network diagram of an example system in accordance with one embodiment.

FIG. 2 is a block diagram of an example user device in accordance with one embodiment.

FIG. 3 illustrates a contactless card in accordance with one embodiment.

FIG. 4 illustrates a transaction card component in accordance with one embodiment.

FIG. 5 illustrates a sequence flow in accordance with one embodiment.

FIG. 6 is a block diagram of an example web server in accordance with one embodiment.

FIG. 7 is a flow chart illustrating various operations of a method in accordance with one embodiment.

FIG. 8 is a flow chart illustrating various operations of a method in accordance with one embodiment.

FIG. 9 illustrates an example of a system configured to operate in accordance with embodiments discussed herein.

FIG. 10 illustrates an example DNS sequence in accordance with one embodiment.

FIG. 11A illustrates an example sequence in accordance with one embodiment.

FIG. 11B illustrates further aspects of the sequence of FIG. 11A, in accordance with one embodiment.

FIG. 11C illustrates further aspects of the sequence of FIG. 11B, in accordance with one embodiment.

FIG. 12 illustrates an example message format in accordance with one embodiment.

FIG. 13 is a flow chart illustrating various operations of an example method in accordance with one embodiment.

FIG. 14 illustrates a network diagram of a validation network in accordance with one embodiment.

FIG. 15 is a flow chart illustrating various operations of another method in accordance with one embodiment.

FIG. 16 is a block diagram of an example computer architecture in accordance with one embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Described herein are techniques that provide solutions to the above deficiencies of the existing security landscape. In one embodiment, the disclosed methods provides a technique for universal identity verification for a FIDO (e.g., FIDO2) passkey (e.g., key) registration. In this embodiment, a user attempts to register a new FIDO passkey at a website and indicates to the website that the user has possession of a contactless card capable of verifying the identity of the user. When referring to a FIDO key herein, this is the same as the FIDO passkey.

The website sends a message to the user's mobile device to prompt the user to tap their contactless card to the mobile device and encrypted data is passed from the contactless card to the mobile device to an authentication server via a switching network. The authentication server performs the authentication of the encrypted data by decrypting the encrypted data and comparing the decrypted data to expected data from the contactless card. The authentication server then sends a message to the contactless card issuer with the user's email address or phone number to verify that the user is the owner of the authenticated contactless card.

The contactless card issuer then verifies that the user's email address or phone number is associated with the contactless card and sends a message back to the authentication server. The authentication server then sends a message to the website server indicating that the FIDO passkey for the user can be stored and associated with the user's email address or phone number (or both).

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed herein may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, the se operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

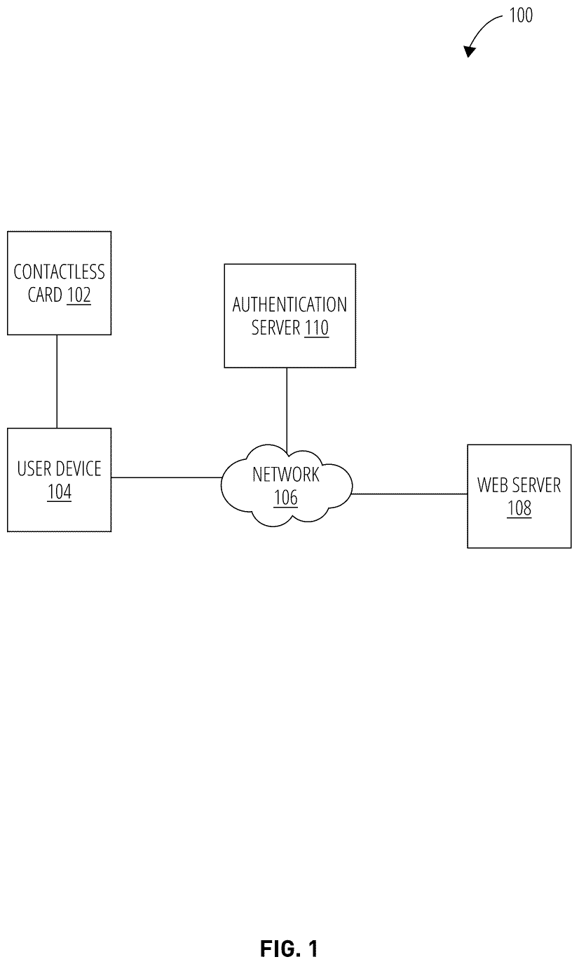

FIG. 1 illustrates a data transmission system 100 according to an example embodiment. As further discussed below, system 100 may include contactless card 102, user device 104, network 106, web server 108, and authentication server 110. Although FIG. 1 illustrates single instances of the components, system 100 may include any number of each of the components.

System 100 may include one or more contactless cards 102, which are further explained below. In some embodiments, contactless card 102 may be in wireless communication, utilizing NFC as an example, with user device 104. For example, the contactless card 102 may be in wireless communication with the user device 104 to send encrypted data to the user device 104. The encrypted data is used to verify an identity of the user or confirm that the user indeed has the contactless card 102 on hand.

System 100 may include user device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. User device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 104 can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The user device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, user device 104 of system 100 may execute one or more applications, such as software applications, that enable, for example, network communications with one or more components of system 100 and transmit and/or receive data.

In embodiments where the user device 104 is a person computer, desktop computer, workstation, or similar computer device, the user device 104 includes a display or monitor, a mouse, a keyboard, one or more input and output devices, and the various processing and memory devices described above.

The user device 104 may be in communication with one or more servers via one or more networks 106. For example, the user device 104 may be in communication with the authentication server 110 and the web server 108 via the network 106. The user device 104 may transmit, for example from a mobile device application executing on user device 104, one or more requests to web server 108. The one or more requests may be associated with retrieving data from web server 108. The web server 108 may receive the one or more requests from user device 104. Based on the one or more requests from user device 104, web server 108 may be configured to retrieve the requested data from one or more databases (not shown). Based on receipt of the requested data from the one or more databases, web server 108 may be configured to transmit the received data to user device 104, the received data being responsive to one or more requests.

System 100 may include one or more networks 106. In some examples, network 106 may be one or more of a wireless network, a wired network or any combination of wireless network and wired network, and may be configured to connect user device 104 to web server 108 and authentication server 110. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more web servers 108. In some examples, web server 108 may include one or more processors, which are coupled to memory. The web server 108 may be configured as a central system, server or platform to control and call various data at different times to execute a plurality of workflow actions. Web server 108 may be configured to maintain a website or application with which the user of the user device 104 attempts to register a FIDO passkey. The web server 108 may be connected to at least one user device 104 via the network 106.

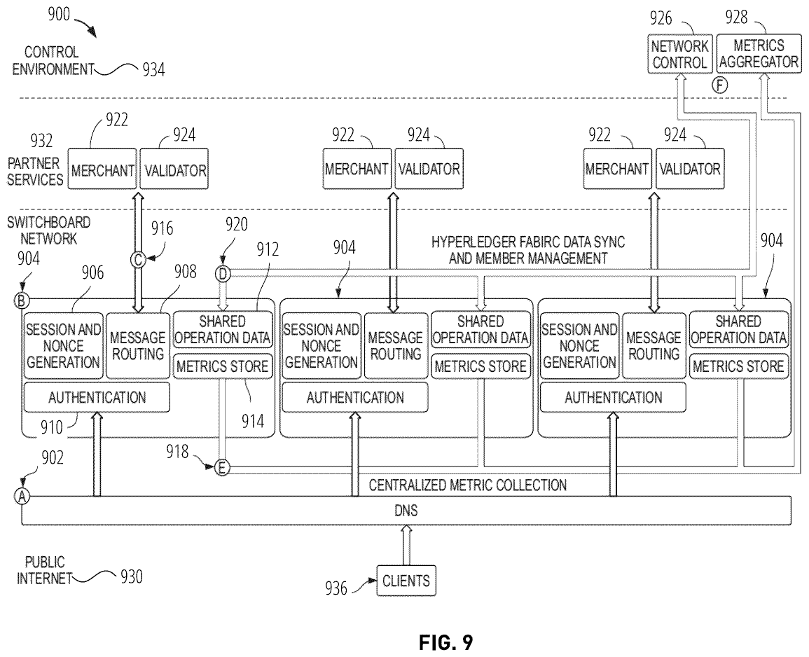

System 100 may further include one or more authentication server 110. In some embodiments, the authentication server 110 may include one or more processors, which are coupled to memory. The authentication server 110 may be configured to decrypt encrypted data from the contactless card 102 and authenticate the user thereof. The authentication server 110 may be a standalone server or may be incorporated into a switching network such as the system 900 described in FIG. 9 below.

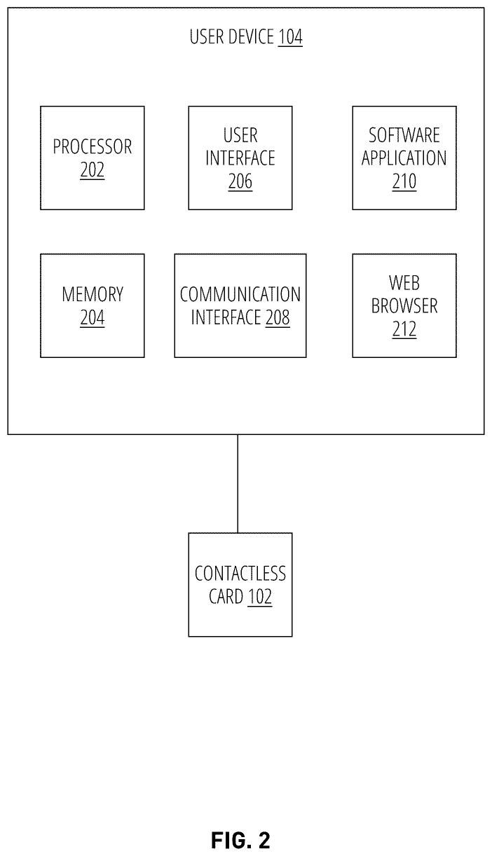

FIG. 2 is a block diagram illustrating various components of an example user device 104 described above. In some embodiments, the user device 104 includes a processor 202, or processing circuit, coupled to memory 204, the memory 204 having executable instructions stored thereon. When the executable instructions are executed by the processor 202, they cause the processor 202, and therefore the user device 104, to perform various operations described herein.

In some embodiments, the user device 104 further includes a user interface 206, a communication interface 208, a software application 210, and a web browser 212.

In some embodiments, the user interface 206 can be a touch screen, such as a screen on a mobile device. In some other embodiments, the user interface 206 can, additionally or alternatively, include one or more buttons, a switch, a movable joystick, or any other suitable user interface. The user interface 206 can further include a monitor or screen that is not a touchscreen, but is instead controlled by separate buttons, a mouse, a keyboard, or any other suitable device. The user interface 206 is configured to receive input from the user and display output to the user. For example, the user interface 206 can display data, including text, pictures, and the like to the user and the user can select or interact with the data displayed.

In some embodiments, the communication interface 208 includes a wired or wireless interface that allows the user device 104 to communicate with devices on the network 106 as well as the contactless card 102. For example, the communication interface 208 can include a wireless interface that communicates with the contactless card 102 via NFC, BlueTooth®, radio frequency identification (RFID), wireless fidelity (Wi-Fi), or any other suitable short range wireless communications protocol. Additionally, the communication interface 208 can include a wireless interface that allows the user device 104 to communicate with other devices on the network 106. For example, the communication interface 208 can include an interface capable of communicating via Wi-Fi or a mobile communications network (e.g., 2G, 3G, 4G, long term evolution (LTE), 5G, 6G, etc.). In some other embodiments, the communication interface 208 includes a wired communication interface whereby the user device 104 is connected to the network 106 via a wired link or cable such as an Ethernet cable or any other suitable wired communications link.

In some embodiments, the user device 104 includes a software application 210 operating thereon, which can be executed by the processor 202 and stored in the memory 204 or another storage device of the user device 104. In some embodiments, the software application 210 can include an application configured to communicate with the contactless card 102 to receive encrypted data therefrom. For example the software application 210 can include a feature where a prompt is displayed on the user device 104 for the user to tap the contactless card 102 to the user device 104 and in response to the user tapping their card, the software application 210 receives the encrypted data from the contactless card 102 and sends the encrypted data to the network 106 for processing.

In some embodiments, the user device 104 further includes a web browser 212 such as a mobile web browser like Safari, Google Chrome, Microsoft Edge, or any other suitable web browser. The web browser 212 can be used by the user to access a website hosted by the web server 108.

In some embodiments, the user device 104 is configured to access, for example, a website on the web browser 212 that is maintained by the web server 108. The user attempts create a user account on the website or otherwise register with the website, a Fast Identity Online (FIDO) passkey associated with the user account of the user. In so doing, the user device 104 sends a request with the FIDO passkey to the web server 108 to register the FIDO passkey. The user can also indicate on the website when attempting to register their FIDO passkey that the user has a contactless card 102 that is capable of sending encrypted data to the authentication server 110 to verify the identity of the user.

In response, the web server 108 will send a message to the user device 104 triggering the software application 210 to execute which allows encrypted data to be received by the user device 104 from the contactless card 102. The software application 210 is executed and a prompt is displayed on the user interface 206 for the user to tap their contactless card 102 to the user device 104. For example, a message is sent from the web server 108 to the user device 104, which causes an element to be displayed on the user interface 206 on the web browser 212, whereby upon interacting with the element, the user device 104 is caused to initiate the software application 210, the software application 210 allowing the user device 104 to receive the encrypted data from the contactless card 102 via near field communication (NFC), radio frequency identification (RFID), Wi-Fi, or Bluetooth®.

In some embodiments, the user device 104 is a mobile device. In such embodiments, the element includes a link, such as a universal resource locator (URL), or a mobile notification. The URL can be displayed as a text message on the mobile device. In some other embodiments, the user device 104 is a desktop computer and the element is a quick response (QR) code which displays on the browser window of the user device 104. In this case, the user will scan the QR code with their mobile device and this will trigger a prompt on their mobile device to tap their contactless card to transfer the encrypted data for authentication.

Upon tapping the contactless card 102, whether the element is displayed on the mobile device or on a desktop of the user, the user device 104 receives the encrypted data from the contactless card 102 and the web server 108 receives the data via the web browser 212. The web server 108 then forwards the encrypted data to an authentication server 110 over a switching network.

If the authentication server 110 authenticates the encrypted data, the FIDO passkey is registered with the web server 108 and the user is permitted to access services on the website using the user account created with the FIDO passkey. If the authentication fails, the FIDO passkey is not registered with the web server 108.

In some embodiments, the request sent from the user device 104 to the web server 108 to register the FIDO passkey includes an email address or phone number for the user. The email address and phone number can be sent by the web server 108 to a card issuer server of the contactless card 102 to confirm that the email address or phone number from the request is also associated with the user account and the contactless card 102.

In some embodiments, the web server 108 can send a link (e.g., URL) to the email address or phone number of the user device 104 the URL can be the element to be displayed on the user interface 206 on the web browser 212 of the user device 104 as discussed above. The URL can be selectable on the user interface 206 of the user device 104 and when the user selects the URL, it causes the software application 210 to execute. This software application 210 will then allow the user device 104 to receive the encrypted data from the contactless card 102 via NFC, RFID, Wi-Fi, or Bluetooth®.

Alternatively, in some embodiments, the request sent from the user device 104 to the web server 108 to register the FIDO passkey includes a selected second factor authentication mode and a user identifier associated with the user account. For example, the user of the user device 104 can select on the user interface 206 a second factor authentication mode when attempting to create the account with the website, and the second factor authentication mode, along with the user identifier will be sent from the user device 104 to the web server 108. In some embodiments, the user can select the second factor authentication mode from modes including a Europay, MasterCard, and Visa (EMV) authentication method, authentication using encrypted data from the contactless card 102 and then routed to the authentication server 110, or a FIDO authentication method. For example, the FIDO authentication method can include a FIDO passkey/public key registered to the financial institution issuer of the contactless card. Alternatively, the FIDO passkey/public key can be registered to another identity verifier. In addition, in some embodiments, the user identifier may include an email address, telephone number, or social media handle associated with the user account associated with the user. Similar to the request described above, the request in this embodiment further includes an indication from the user account that the user account has the contactless card 102 associated therewith, the contactless card 102 being configured to perform the second factor authentication of the user account.

In these alternative embodiments, once the web server 108 receives the request to register the FIDO passkey, along with the selected second factor authentication mode and the user identifier, the web server 108 is configured to send a prompt to a mobile device associated with the user account and the user identifier (e.g., the user's email address or phone number). The mobile device may be the user device 104 or it may be another mobile device associated with the user. The prompt may include a URL or notification similar to that described above. In some embodiments, the prompt includes a prompt to perform second factor authentication using the mobile device and with an authentication server. Performing the second factor authentication includes using a contactless card 102 associated with the user account and performing the second factor authentication in a manner corresponding to the selected second factor authentication mode selected by the user.

Once the authentication sever verifies to the web server 108 that the second factor authentication is successful (e.g., that the EMV authentication method, encrypted data from the contactless card 102 is validated, or that the FIDO authentication method is successful), the web server 108 will grant the request to register the FIDO passkey for the user account with the website associated with the web server 108.

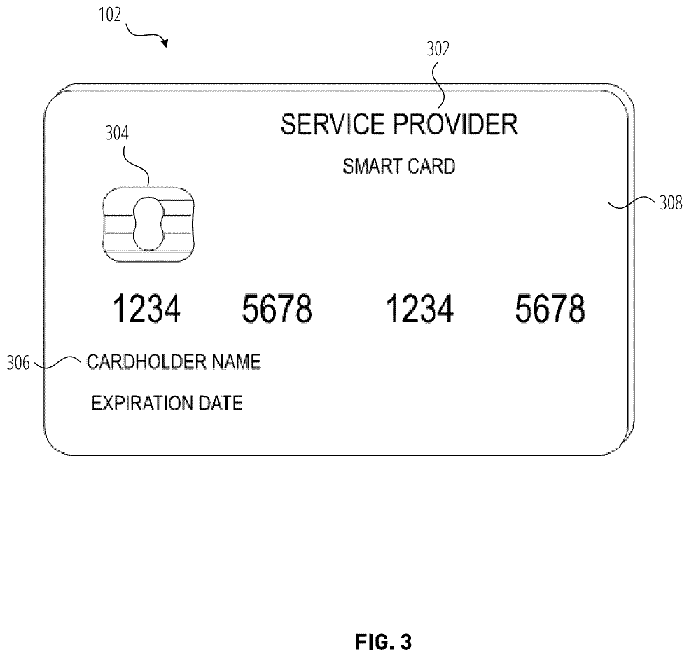

FIG. 3 illustrates an example configuration of a contactless card 102 from FIG. 1 and FIG. 2 above. The contactless card 102 may include a contactless card, a payment card, such as a credit card, debit card, or gift card, issued by a service provider as displayed as service provider indicia 302 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

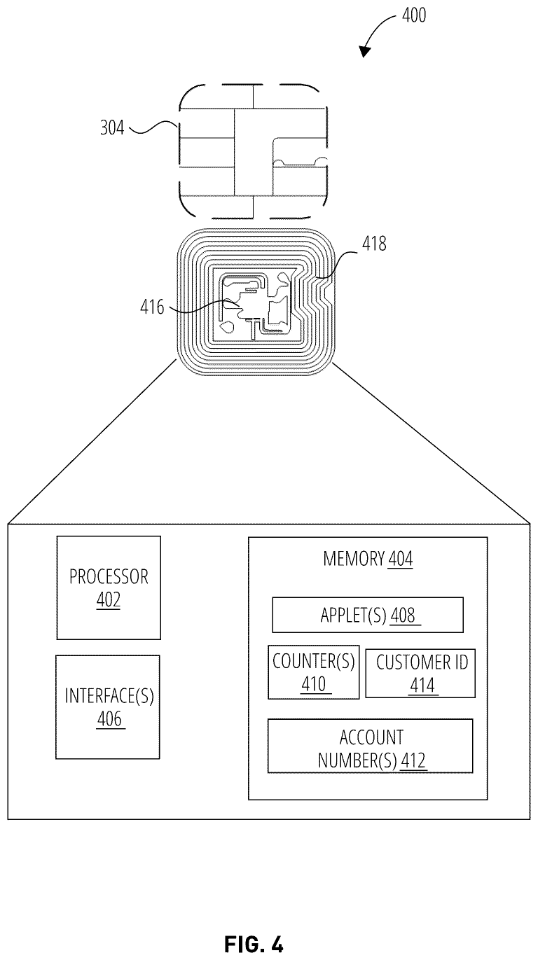

The contactless card 102 may also include identification information 306 displayed on the front and/or back of the card, and a contact pad 304. The contact pad 304 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 4. These components may be located behind the contact pad 304 or elsewhere on the substrate 308, e.g. within a different layer of the substrate 308, and may electrically and physically coupled with the contact pad 304. The contactless card 102 may also include a magnetic strip or tape, which may be located on the back of the card (not shown in FIG. 3). The contactless card 102 may also include a Near-Field Communication (NFC) device coupled with an antenna capable of communicating via the NFC protocol. Embodiments are not limited in this manner.

As illustrated in FIG. 4, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions described herein.

In some embodiments, the processing circuitry 416 of the contactless card 102 is configured to send the encrypted data to the user device 104 when the user taps the contactless card 102 to the user device 104. In embodiments where the user device 104 is a desktop computer or non-mobile device, the user device 104 will have a wireless NFC reader, BlueTooth® low energy reader, or other device attached thereto to read the encrypted data from the contactless card 102. Alternatively, when the user device 104 is a desktop computer, or other non-mobile device, the web server 108 will send a link to the user's mobile device for the user to select and selecting the URL will trigger a prompt on the mobile device for the user to tap their contactless card 102 to the mobile device to read the encrypted data.

The memory 404 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypted data.

The memory 404 may be configured to store one or more applet(s) 408, one or more counter(s) 410, a customer identifier 414, and the account number(s) 412, which may be virtual account numbers. The one or more applet(s) 408 may comprise one or more software applications configured to execute on one or more contactless cards, such as a Java® Card applet. However, it is understood that applet(s) 408 are not limited to Java Card applets, and instead may be any software application operable on contactless cards or other devices having limited memory. The one or more counter(s) 410 may comprise a numeric counter sufficient to store an integer. The customer identifier 414 may comprise a unique alphanumeric identifier assigned to a user of the contactless card 102, and the identifier may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device or a user device 104 for autofilling by an autofilling service.

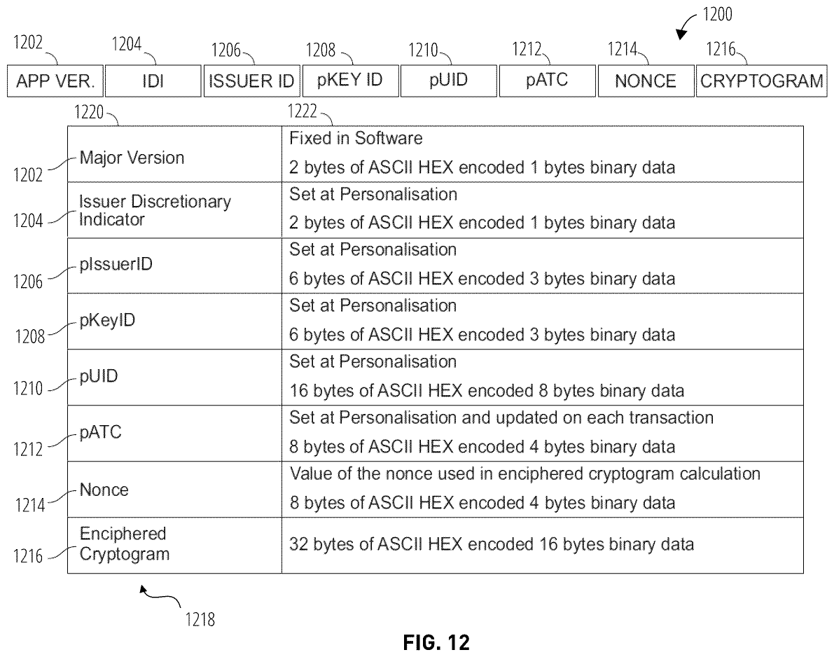

In some embodiments, the memory 404 can include (e.g., have stored therein) the data from the fields shown in FIG. 12. The processor 402 can then use the data from the fields to generate the message 1200 as described above. This message 1200, inter alia, is included in the encrypted data discussed above.

The processor 402 and memory elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the contactless card 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 102 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when the user device 104 is woken up, NFC may be enabled and the user device 104 may be configured to read available tags, but no action is taken responsive to the reads.

To keep the counter(s) 410 in sync, an application, such as a background application, may be executed that would be configured to detect when the mobile user device 104 wakes up and synchronize with the server of a banking system indicating that a read that occurred due to detection to then move the counter(s) 410 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique described herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

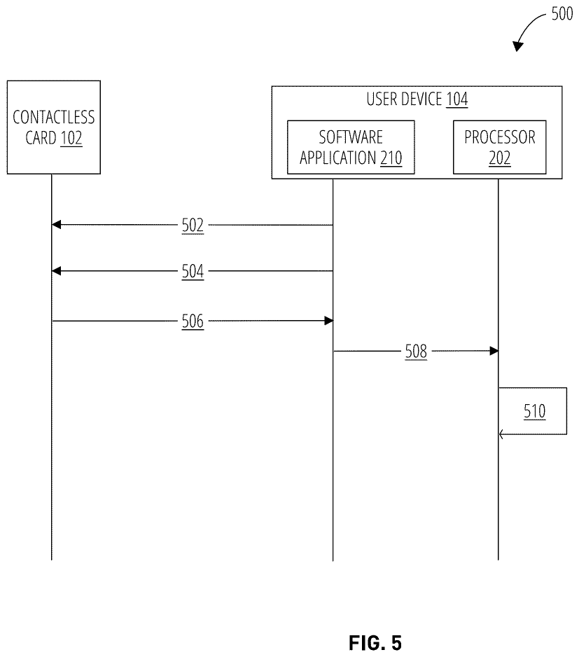

FIG. 5 is a timing diagram illustrating an example sequence for providing authenticated access according to one or more embodiments of the present disclosure. Sequence flow 500 may include contactless card 102 and user device 104, which may include a software application 210 and processor 202.

At line 502, the software application 210 communicates with the contactless card 102 (e.g., after being brought near the contactless card 102). Communication between the software application 210 and the contactless card 102 may involve the contactless card 102 being sufficiently close to a card reader (not shown) of the user device 104 to enable NFC data transfer between the software application 210 and the contactless card 102.

At line 504, after communication has been established between user device 104 and contactless card 102, contactless card 102 generates a message authentication code (MAC) cryptogram. In some examples, this may occur when the contactless card 102 is read by the software application 210. In particular, this may occur upon a read, such as an NFC read, of a near field data exchange (NDEF) tag, which may be created in accordance with the NFC Data Exchange Format. For example, a reader application, such as software application 210, may transmit a message, such as an applet select message, with the applet identifier (ID) of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, processor 202 may be configured to transmit a request to contactless card 102, the request comprising an instruction to generate a MAC cryptogram.

At line 506, the contactless card 102 sends the MAC cryptogram to the software application 210. In some examples, the transmission of the MAC cryptogram occurs via NFC, however, the present disclosure is not limited thereto. In other examples, this communication may occur via Bluetooth, Wi-Fi, or other means of wireless data communication. At line 508, the software application 210 communicates the MAC cryptogram to the processor 202.

At line 510, the processor 202 verifies the MAC cryptogram pursuant to an instruction from the software application 210. For example, the MAC cryptogram may be verified, as explained below. In some examples, verifying the MAC cryptogram may be performed by a device other than user device 104, such as a server of a banking system in data communication with the user device 104. For example, processor 202 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

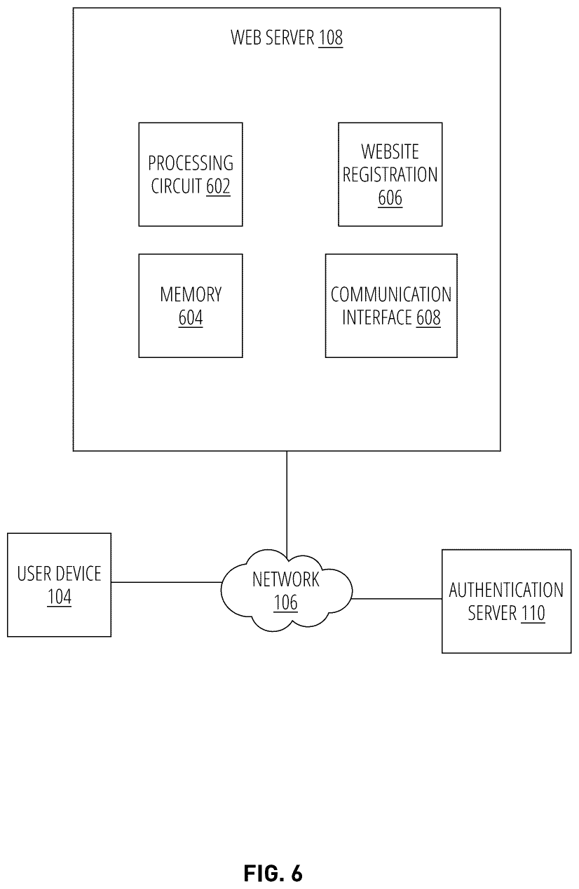

FIG. 6 is a block diagram illustrating example components of the web server 108 described above in FIG. 1. Additionally, FIG. 6 includes the web server 108 in a network diagram with the user device 104, network 106, and web server 108 to help visualize the various communication paths therebetween. In some embodiments, the web server 108 includes a processing circuit 602 coupled with a memory 604. The web server 108 further includes a website registration 606 and a communication interface 608.

The processing circuit 602 can include any suitable processing circuit or processor capable of executing instructions stored in the memory 604. For example, the processing circuit 602 can include a central processing unit (CPU), general purpose processor, single or multi-core processor, microprocessor, controller, application specific integrated circuit (ASIC), or any other suitable processing circuit. The memory 604 can include random access memory (RAM), read only memory (ROM), a hard disk drive (HDD), a solid state drive (SSD), electrically erasable programmable read-only memory (EEPROM), or any other suitable memory device for storing executable instructions. In some embodiments, the processing circuit 602 is configured to execute the executable instructions stored in the memory 604, which when executed by the processing circuit 602, causes the web server 108 to perform various operations described hereinbelow.

In some embodiments, the website registration 606 can include a website maintained by the web server 108. The website will include a function for registering a user account therewith. The website registration 606 includes the function of registering the user account as well as registering the FIDO passkey with that user account. In an alternative embodiment, the web server 108 can be an application server wherein the website registration 606 handles registration of user accounts and FIDO passkeys for the application. For example, the application can be a mobile application that operates on a mobile device, such as a banking application, a social media application, a streaming platform, a gaming application, or any other suitable application. In this case, the website registration 606 will be a mobile application registration service that registers the user accounts for the application as they are created and registers the FIDO passkeys.

In some embodiments, the communication interface 608 includes a wired or wireless communication interface capable of transmitting data to and receiving data from the network 106. For example, in some embodiments, the communication interface 608 includes an Ethernet interface connected to networking equipment that is part of or connected to the network 106.

In some embodiments, the web server 108 is configured to receive a request from a computing device (e.g., user device 104) associated with a user account to register, with the website registration 606, a Fast Identity Online (FIDO) passkey associated with the user account. The request can be received simultaneously with a request to create a new user account with the web server 108 or for a user account that was already created.

In some embodiments, in response to receiving the request, the processing circuit 602 of the web server 108 is configured to send the computing device a message including an element for display on a web browser or otherwise on a display or screen of the computing device. For example, in some embodiments, the element for display includes a quick response (QR) code. In some embodiments, the computing device is a desktop computer, workstation, personal computer, server, or cloud device being used by the user to access the web server 108 and the website registration 606. The processing circuit 602 sends the QR code to the desktop computer and it is displayed on the web browser for interacting with by the user. In such an embodiment, interacting with the element or QR code includes using a mobile device in possession of the user to scan the QR code, which causes the software application 210 to be executed on the mobile device to thereby receive encrypted data from the contactless card 102, as described above in FIG. 5.

In some other embodiments, the element for display includes a digital link to be interacted with by the user. For example, in some embodiments, the element for display can include a universal resource identifier (URI) or a universal resource locator (URL) link to be interacted with by the user. For example, the web server 108 can send the computing device of the user a text message or email (e.g., using a phone number or email address sent from the user to the web server 108 when attempting to register the FIDO passkey) with the URL to be displayed on the browser or screen of the computing device. The user can then select the URL on the screen of the mobile device or the desktop computer and this will cause the software application 210 to execute on the mobile device. In some other embodiments, the web server 108 is to cause a pop-up window to be displayed on the screen or web browser of the computing device. The pop-up window can include a digital button for the user to select using their finger or a mouse or other user input device. In an alternative embodiment, the web server 108 causes a digital button to be displayed on the webpage for the user to select with the user input device.

In some embodiments, the element is to be interacted with by the user of the computing device, wherein upon interacting with the element, the software application 210 on the mobile device of the user associated with the user account is executed. In some embodiments, the software application 210 is configured to permit the mobile device of the user to receive encrypted data from a contactless card 102 associated with the user account.

Those having ordinary skill in the art will appreciate that the computing device (e.g., desktop computer) and the mobile device may be separate devices in the possession of the user. In some other embodiments, the computing device and the mobile device are one in the same device. The user can use the mobile device to access the web server 108 and the website registration 606 to attempt to register the FIDO passkey and the element (e.g., a button or popup) is sent to the mobile device. In the case where the user is using a desktop or workstation computer, the desktop or workstation is used for connecting to the website and the mobile device is only used for obtaining the encrypted data from the contactless card 102 for authentication purposes.

In some embodiments, the authentication server 110 receives the encrypted data from the web server 108 and then uses a decryption algorithm that is known between the contactless card 102 and the authentication server 110 to decrypt the encrypted data. The authentication server 110 then compares the decrypted data to expected data for the contactless card 102. If the decrypted data from the contactless card matches the expected data, the authentication server 110 sends a message to the web server 108 indicating that the user's identity has been verified. In some embodiments, in response to receiving, from the authentication server 110, an authentication response indicating that the identity of the user account associated with the mobile device has been validated, the web server 108 is configured to grant the request from the computing device and register the FIDO passkey associated with the user account with the website.

In response to receiving, from the authentication server 110, an authentication message indicating that the identity of the user account that sent the request is not validated, the web server 108 is configured to deny the request from the user account to register the FIDO passkey and the FIDO passkey is not registered.

In some embodiments, the processing circuit 602 is configured to generate a session ID associated with the request to register the FIDO passkey and send the session ID with the message to the computing device that includes the element for display. The session ID is to be sent to the mobile device when the mobile device interacts with the element, and the mobile device is to send the session ID to web server 108 along with the encrypted data to be forwarded to the authentication server 110. Alternatively, the mobile device of the user can bypass the web server 108 and send the encrypted data, along with the session ID, directly to the authentication server 110 for authentication to be performed. In some embodiments, the authentication response sent from the authentication server 110 to the web server 108 can include the session ID to indicate to the web server 108 which user account is being authenticated.

In some embodiments, when attempting to register the FIDO passkey with the web server 108, the user includes a user identifier, such as an email address, phone number, or social media handle or username with the request. The user identifier can be used to send, for example, the element (e.g., the URL discussed above) to the mobile device of the user. In addition, in some embodiments, the web server 108 is configured to send a message to a card issuer (e.g., a card issuer server) of the contactless card 102 requesting confirmation that the email address or phone number from the request is also associated with the user account and the contactless card 102. In some embodiments, the web server 108 receives a reply to the message to the card issuer. In response to the reply from the card issuer indicating that the email address or phone number associated with the user account is also associated with the contactless card 102, the web server 108 is to grant the request from the user account and register the FIDO passkey. In response to the reply from the card issuer indicating that the email address or phone number associated with the user account is not also associated with the contactless card 102, the web server 108 is to deny the request from the user account and not register the FIDO passkey. This email and phone number check is a second authentication factor in addition to the authentication of the encrypted date from the contactless card 102.

In some embodiments, along with the request to register the FIDO passkey, the web server 108 receives a selected second factor authentication mode, for authenticating the user's identity, with the request. In some embodiments, the second factor authentication mode can be selected by the user on the user device 104 such as the mobile device or the computing device at the time they attempt to register the FIDO passkey. In some embodiments, the second factor authentication mode includes authentication using an EMV authentication method, authentication using encrypted data from the contactless card 102 routed to the authentication server 110, or a FIDO authentication method.

That is, instead of the link or element being automatically sent to the user device 104 to initiate the software application 210 to receive the encrypted data from the contactless card 102 and send to the authentication server 110, the user may select which form of second factor authentication is used. If the user selects the mode for sending the encrypted data from the contactless card 102 to the user device 104, the request from the user to the web server 108 can also include an indication that the user account has a contactless card 102 associated therewith (e.g., a contactless card configured to perform the second factor authentication), and the element is sent by the web server 108 to the computing device or mobile device to so that the user can tap the contactless card 102. However, if the EMV method or the FIDO authentication method is sent, the element will not be sent as described above.

In another alternative embodiment, some of the functions described above can be performed by another server that is not the host of the website, but instead is a FIDO passkey registration server that is in communication with the web server 108. The other server can communicate with the user device 104 and the authentication server 110 and then inform the web server 108 when the authentication process is complete and when the FIDO passkey is registered. The web server 108 will then allow the user device 104 to access services of the web server 108.

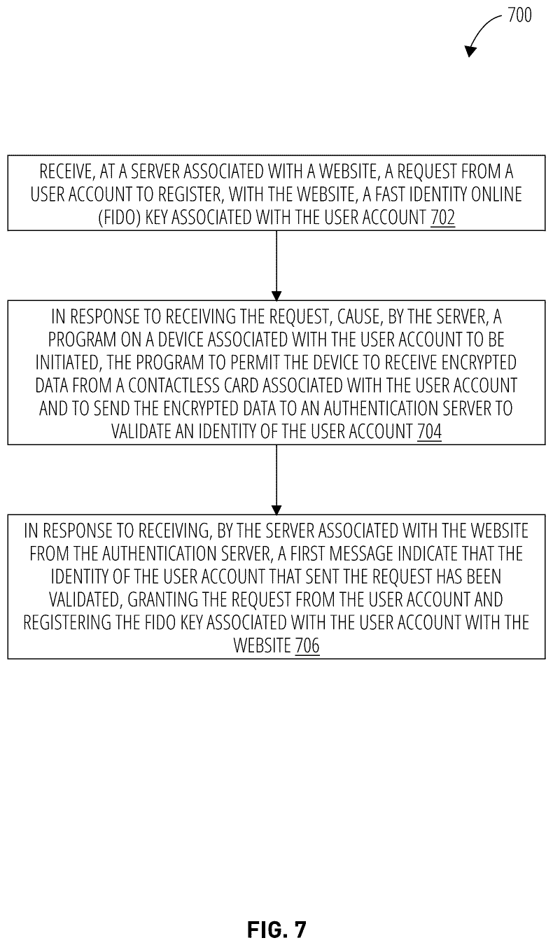

FIG. 7 is a flow diagram illustrating various operations in an example method 700 for universal identity verification for FIDO passkey registration. As shown at block 702, in some embodiments, the method 700 includes receiving, at a server associated with a website, a request from a user account to register, with the website, a Fast Identity Online (FIDO) passkey associated with the user account. As shown at block 704, the method 700 includes, in response to receiving the request, causing, by the server, a program on a device associated with the user account to be initiated, the program to permit the device to receive encrypted data from a contactless card associated with the user account and to send the encrypted data to an authentication server to validate an identity of the user account. As shown at block 706, the method 700 includes, in response to receiving, by the server associated with the website from the authentication server, a first message indicating that the identity of the user account that sent the request has been validated, granting the request from the user account and registering the FIDO passkey associated with the user account with the website.

In some embodiments, the method 700 further includes, in response to receiving, by the server associated with the website from the authentication server, a second message indicating that the identity of the user account that sent the request is not validated, denying the request from the user account to register the FIDO passkey. In some embodiments, the request from the user account includes an indication to the server associated with the website, that the user account has a contactless card associated therewith. In some further embodiments of the method 700, causing, by the server, the program on the device to be initiated includes, causing an element to be displayed on a browser associated with the user account, whereby upon interacting with the element, the device is caused to initiate the program, the program allowing the device to receive the encrypted data from the contactless card via near field communication (NFC), radio frequency identification (RFID), Wi-Fi, or Bluetooth®. In some embodiments, the device is a mobile device and the element includes a universal resource locator (URL) or a mobile notification.

In some embodiments, the user account includes an email address or phone number associated therewith and the request sent from the user account includes the email address or phone number. In some embodiments, the method 700 further includes sending, by the server associated with the website, a third message to a card issuer server of the contactless card requesting confirmation that the email address or phone number from the request is also associated with the user account and the contactless card. In some embodiments, the method 700 further includes receiving a reply to the third message from the card issuer server. In response to the reply from the card issuer indicating that the email address or phone number associated with the user account is also associated with the contactless card, the method 700 includes granting the request from the user account and registering the FIDO passkey. Alternatively, in response to the reply from the card issuer indicating that the email address or phone number associated with the user account is not also associated with the contactless card, the method 700 includes denying the request from the user account and not registering the FIDO passkey.

In some embodiments of the method 700, causing, by the server, the program on the device to be initiated includes sending a communication to the email address or phone number associated with the user account, the communication including a link selectable on a user interface of the device to cause initiation of the program on the device, the program allowing the device to receive the encrypted data from the contactless card via near field communication (NFC), radio frequency identification (RFID), Wi-Fi, or Bluetooth®.

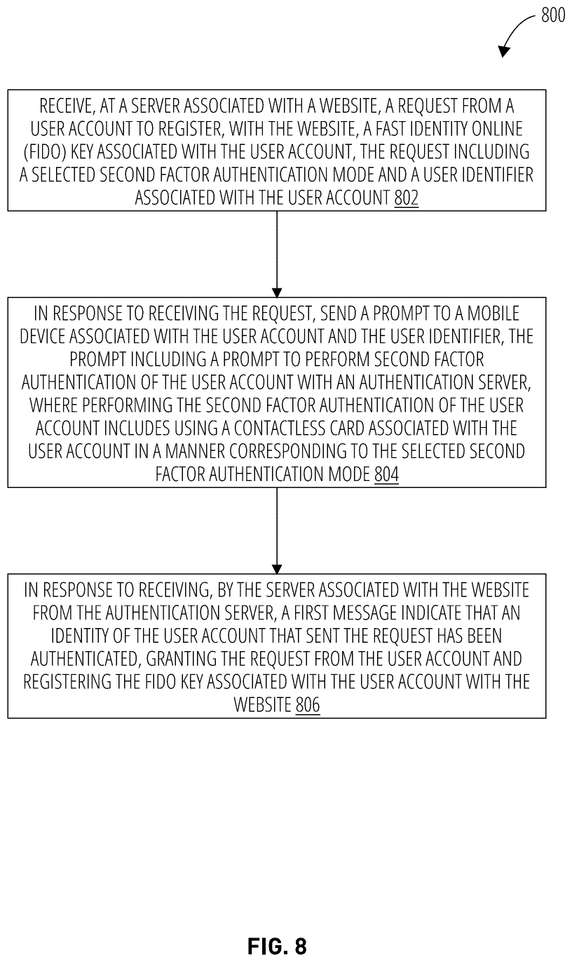

FIG. 8 is a flow chart illustrating various operations in another example method 800 for universal identity verification for FIDO passkey registration. As shown at block 802, in some embodiments, the method 800 includes receiving, at a server associated with a website, a request from a user account to register, with the website, a Fast Identity Online (FIDO) passkey associated with the user account, the request including a selected second factor authentication mode and a user identifier associated with the user account. As shown at block 804, in response to receiving the request, the method 800 includes, sending a prompt to a mobile device associated with the user account and the user identifier, the prompt including a prompt to perform second factor authentication of the user account with an authentication server, where performing the second factor authentication of the user account includes using a contactless card associated with the user account in a manner corresponding to the selected second factor authentication mode. As shown at block 806, in response to receiving, by the server associated with the website from the authentication server, a first message indicates that an identity of the user account that sent the request has been authenticated, the method 800 includes, granting the request from the user account and registering the FIDO passkey associated with the user account with the website.

In some embodiments, in response to receiving, by the server from the authentication server, a second message indicating that the identity of the user account that sent the request is not authenticated, the method 800 includes denying the request from the user account to register the FIDO passkey. In some embodiments, the selected second factor authentication mode includes authentication using a Europay, MasterCard, and Visa (EMV) authentication method, authentication using encrypted data from the contactless card routed to the authentication server, or a FIDO authentication method.

In some embodiments, the user identifier includes an email address, telephone number, or social media handle associated with the user account. Additionally, in some embodiments, the request further includes an indication from the user account that the user account has the contactless card associated therewith, the contactless card configured to perform the second factor authentication of the user account.

FIG. 9 illustrates an example of system 900 in accordance with the embodiments discussed herein. The system 900 includes additional devices and systems configured to enable contactless card issuers to tap-to-card services. Specifically, system 900 enables any number of issuer systems to provide card services to their clients through a switching fabric, i.e., the switchboard system in a secure and safe manner. System 900 is an example switching network described above. Authentication 910 device of system 900 can include or act as the authentication server 110 described above and the merchant system 922 can be the web server 108 or other server associated with the website described above. The client 936 can include the web server 108, the user device 104, or the issuer server. For example, when the contactless card 102 sends the encrypted data to the user device 104, as described above, the user device 104 can forward the data to the web server 108 for forwarding to the authentication 910 or the user device 104 can forward the encrypted data directly to the authentication 910 through the DNS 902. Alternatively, the user device 104 can forward the encrypted data to the issuer server (e.g., a server associated with and maintained by the issuer of the contactless card 102) and the issuer server can then forward the encrypted data to the authentication 910 via the system 900 for authentication.

In embodiments, the switchboard system includes one or more nodes 904 configured to perform routing operations. Each switchboard node 904 may include a session and nonce generator 906, a message router 908, an authentication 910, an operation data 912 store, and a metrics store 914. Further, each of the nodes may be configured the same and share configurations, but each switchboard node 904 may independently process and route messages and requests to the appropriate systems, such as the merchant systems and issuer systems. Each of the nodes 904 is configured to act as a broker of trust between an issuer system, the merchant system 922, and/or validation system 924, for example. Each switchboard node 904 is configured to route each message to the correct issuer system while maintaining data security. For example, a switchboard node 904 may route a message between an issuer system and a merchant system while the node cannot access the private data in the message.

The switchboard system 900 may be configured as a server system with a collection of hardware, software, and networking components that work together to provide client services. Hardware components may include one or more server computers, storage devices, and network adapters. The server computers are configured to run server applications, such as those executable on each of the nodes 904. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

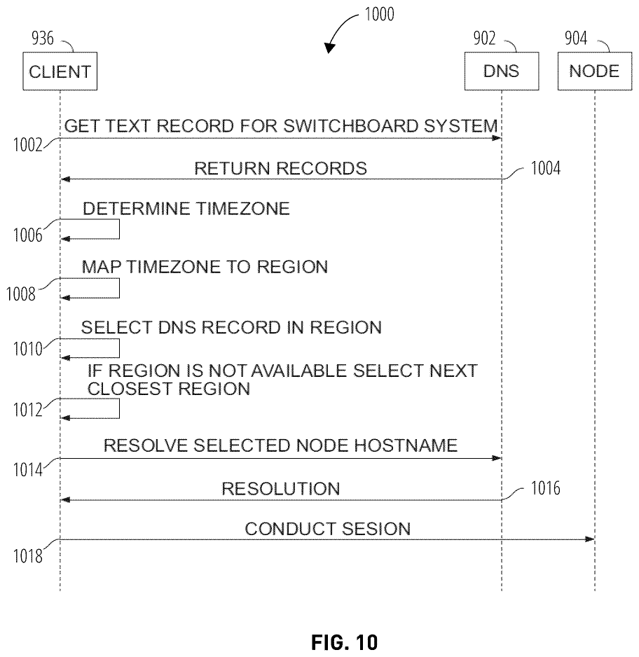

In some embodiments, the nodes 904 may operate in a cloud-based computing environment, e.g., a collection of hardware, software, and networking components that enable the delivery of cloud computing services. The switchboard nodes 904 and the computing services are delivered over the Internet and can be accessed from anywhere in the world with an Internet connection. In embodiments, client 936 may access a switchboard node 904 through DNS 902 or Domain Name System (DNS). The DNS 902 is a hierarchical and distributed naming system for computers, services, and other resources connected to the Internet or other networks. It associates various information with domain names assigned to each registered participant. In one example, the DNS 902 may translate a name known to software executing on a client 936 to route data to one or more of switchboard node 904 of the switchboard system. In embodiments, the DNS 902 may generate a number, such as an Internet Protocol (IP) address, an address record (A-record), or another Hostname (C-name record). FIG. 10 illustrates one example sequence 1000 for a client to identify and resolve an identifier for one of the nodes 904 of the switchboard system. At a high level, the DNS 902 translates known domain names to numerical Internet Protocol (IP) addresses needed for locating and identifying computer services and devices with the underlying network protocols. Clients use the global DNS system to select the best node to use, as discussed in sequence 1000.

In embodiments, a client 936 communicates with the switchboard system to perform one or more of the partner services 932, such as conducting a transaction with a merchant, validating the customer, or other tap-to functions. Once client 936 identifies a switchboard node 904 and resolves an address to communicate with switchboard node 904, client 936 may send one or more messages to switchboard node 904 to authenticate and perform the operation. The switchboard node 904 includes an authentication 910 function that is configured to authenticate the client 936. In embodiments, the client 936 sends a message or authorization request to the switchboard node 904 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 904 may authorize or authenticate the client 936 or user, and the switchboard node 904 may utilize the additional components, such as the session and nonce session and node generator 906 and message router 908, to perform the operations. Note the validation systems validation system 924 never interact with the merchant systems 922, nor vice versa. The nodes node 904 brokers all communication.

In embodiments, the switchboard system may utilize a hyper ledger fabric 920 to manage to synchronize the shared operation data 912 and member management across the network. The hyperledger fabric 920 is distributed ledger framework having a permissioned network model that only authorized participants can join the network and access the data that is stored on a ledger.

In embodiments, the hyperledger fabric 920 may be generated by creating one or more sets of peers, an ordering service, and a channel. Once the network is created, system 900 deploys chaincode to the network, or node 904 is permitted to access the fabric. The chaincode is the code that runs on the blockchain and executes the network control 926 and operation data 912 logic code. Once the chaincode is deployed, each of the switchboard nodes 904 is configured to invoke transactions on the blockchain to add data to the blockchain, e.g., the operational data. A switchboard node 904 or another device can query the ledger to retrieve data. The ledger is a distributed database that stores all the data added to the blockchain.

All nodes 904 keep an independently verifiable log of their actions that can be transmitted to a centralized aggregator to build a picture of overall network usage. System 900 can manage network operation data and management at a central level and have a centralized view of network use, aggregated and abstracted to the appropriate level.

FIG. 10 illustrates an example sequence 1000 for a client to utilize DNS to resolve and communicate with one or more nodes of a switchboard system. The illustrated sequence 1000 includes a client 936, a DNS 902, and a switchboard node 904. At 1002, the sequence 1002 includes the client 936 sending a request to a default DNS server for a text record switchboard. {domain}. {tld}. The text record may be preconfigured in a client app and/or client SDK. At 1004, the DNS 902 returns one or more records. A DNS record structure may include the following:
Root Record:
   Name: switchboard. {domain}. {tld}
   Type: TXT
   · Resolution:
      “{nodename_1}. {operator_a}. {region_i}.switchboard. {domain}. {tld},
      {nodename_2}. {operator_a}. {region_i}.switchboard. {domain}. {tld},
      {nodename_1}. {operator_b}. {region_ii}.switchboard. {domain}. {tld},
      {nodename_2}. {operator_b}. {region_ii}.switchboard. {domain}. {tld},
      * etc.
   Used For determining where there are active nodes
Node Record:
   Name: {nodename}. {operator}. {region}.switchboard. {domain}. {tld}
   Type: A/AAAA or CNAME
   Resolution: Actual node hostname or IP
   Used For: communicating with a node 904

In embodiments, the client 936 may determine the current timezone at 1006. For example, the client app or SDK may utilize a get current timezone function, such as in JavaScript: Intl.DateTimeFormat ( ) resolvedOptions ( ) timeZone). Embodiments are not limited in this manner, and the app or sdk may determine the timezone via another/different function call. At 1008, the client 936 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1010, the client 936 may identify or select a DNS record option returned at 1004 that is in the region. If there are multiple matches, the client 936 may select one at random. If there's no node available in a region, the client 936 may determine and use a data graph of neighboring regions to select a node in the closest region where a node is available at 1012. For example, sa has no node but is connected to na-e where there is a node and so na-e is selected. In some embodiments,

At 1014, the client may resolve a selected node's hostname. In embodiments, the client 936 may automatically resolve the hostname using the client's HTTP request default resolver. At 1016, the DNS 902 may return a result. And at 1018, the client 936 may communicate with a switchboard node 904 and begin the process to interact with the switchboard.

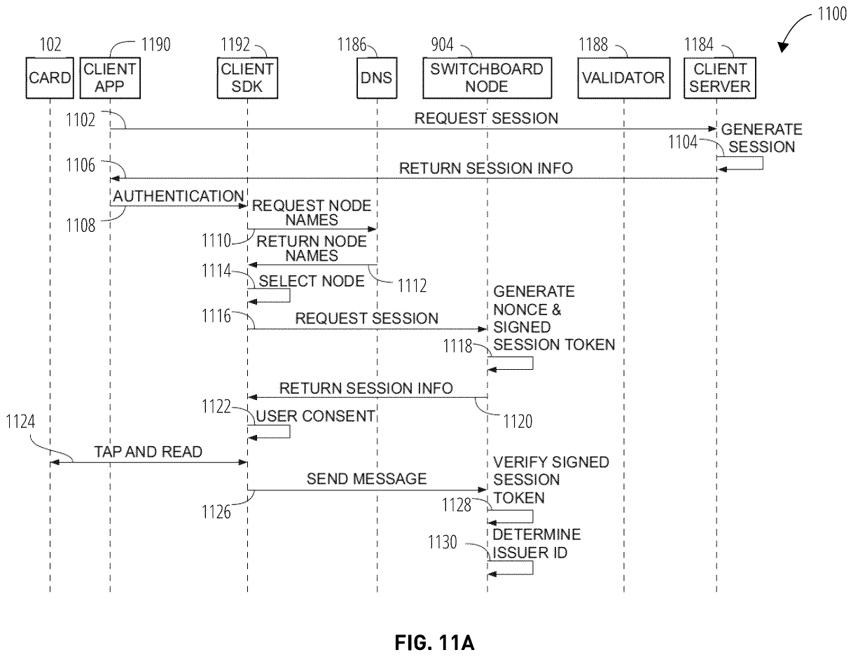

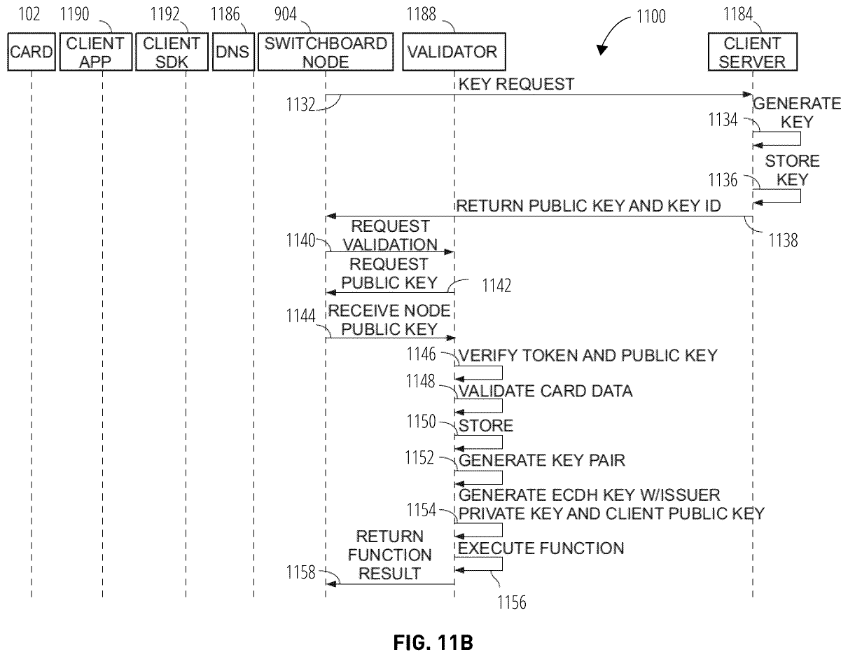

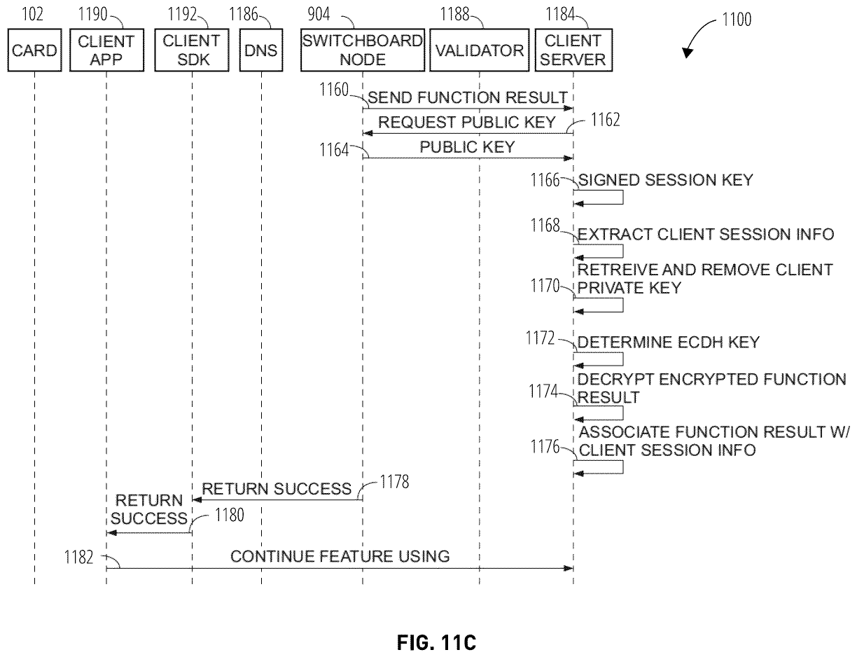

FIG. 11A-FIG. 11C illustrate an example sequence 1100 to perform operations between a contactless card and services provided by a card issuer, a website or web server 108 and/or merchant. The illustrated sequence 1100 includes actions and communications performed by a contactless card 102, a client 936 including a client app 1190 and a client SDK 1192, a DNS 1186, a switchboard system including one or more nodes 904, a partner services 932, including a merchant web server 108, and/or validator 1188, and control services 934 including a client server 1184 or system. In embodiments, the client app 1190 may be any application configured to execute on a client 936, such as a banking app, a merchant app, a social media app, a travel app, a gaming app, a productivity app, an entertainment app, and so forth. Alternatively, the client app 1190 can be a website and instead of an application, the website being accessed by the user device 104. The client app 1190 may include and/or utilize the client SDK 1192, which may be a set of instructions that enable the client app 1190 to communicate with other components of the switchboard system.

In embodiments, as shown in FIG. 11A, at 1102 the client 936 including the client app may send a request and establish a session with a client server 1184 such that a result may be associated with the correct client device or user. The request establishes a relationship between the client device and client server, which may be an issuer server. At 1104, the client server 1184 generates a session and CLIENT SESSION INFORMATION. At 1106, the client server 1184 returns the session information, e.g., the CLIENT SESSION INFORMATION. In embodiments, the CLIENT SESSION INFORMATION may be the Client implementation-specific user session identification information.

At 1108, the client 936 may initiate a contactless card authentication process with the client 936. For example, the client 936 may call a function and/or pass information to the client 936 to initiate authentication via a contactless card 102. At 1110-1114, the client 936 may utilize DNS to identify a node and establish communication with the node. Specifically, at 1110, the client 936 including the client SDK 1192 may send a request for switchboard hostnames, and at 1112 the DNS 1186 may return information including one or more hostnames. At 1114, the client 936 may determine a switchboard node to communicate. FIG. 10 illustrates an example of a more detailed sequence of the process to establish communication with a switchboard node 904.

At 1116, the client 936 may send a request for a session to the switchboard system 900. In embodiments, the request for a session may be for a function request in the format <FUNCTION REQUEST>. In embodiments, the FUNCTION REQUEST may be the data/function that the client 936 would like to request once a contactless card 102 has been validated. The function could be for any service discussed herein, e.g., authenticate the user, perform a transaction, request autofill data, etc. At 1118, switchboard system 900 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),.
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and<FUNCTION REQUEST>signed with <NODE PRIVATE KEY>, where the NODE PRIVATE KEY is the switchboard system 900 private key. The switchboard system 900 may include a NODE PUBLIC/PRIVATE KEY, which is a keypair used to sign and validate JWTs.

At 1120, the switchboard system 900 may return session information to the client 936. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1122, the client SDK 1192 may determine and/or receive user consent to the terms of service. In one example, the client SDK 1192 captures and records the user consent to<FUNCTION TOS>on<CONSENT DATE>with<TOS VERSION>. The CONSENT DATE may be the timestamp for the user's consent to the TOS.

At 1124, the client 936 exchanges one or more messages with a contactless card. In one example, the exchange may be based on the contactless card being tapped to a client device. In embodiments, the client SDK 1192 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes |
| 0E | | binary data |
| 0F . . . | Session | 4 bytes of ASCII HEX encoded 2 bytes |
| 12 | Indicators | binary data |
| 13 . . . | Control | 4 bytes of ASCII HEX encoded 2 bytes |
| 16 | Indicators | binary data |
| 17 . . . | Update Date | 16 bytes of ASCII HEX encoded 8 bytes |
| 26 | creation Time | binary data - represents 64 bit unix |
| | | timestamp |
| 27 . . . | Update MAC | MAC to protect control indicators - 16 bytes |
| 36 | | of ASCII HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 12, message 1200.

At 1124, the contactless card may generate and provide a message to the client's device including the client SDK 1192. The data in the message may be utilized by the system discussed herein to perform the function requested. One example of the message is illustrated and discussed in FIG. 12, message 1200.

At 1126, the client including the client SDK 1192 may send a message and information to the switchboard system 900. The message may be the message received from the contactless card 102, e.g., message 1200. In addition, the client SDK 1192 may send the consent date, the TOS version, and the signed session token to the switchboard system 900. The switchboard system 900 may utilize the information to ensure the session is valid. At 1128, the switchboard system 900 verifies the signed session token is valid, e.g., is the previously provided signed session token and includes the nonce previously generated and is in the message.

In some embodiments, the switchboard system 900 is configured to determine which issuer system or client-server it should route the message to for processing. At 1130, the switchboard system 900 may determine the issuer ID by extracting it from the message received from the contactless card 102 via the client SDK 1192. As mentioned, the issuer ID identifies the issuer of the contactless card 102.

FIG. 11B continues the sequence 1100 from FIG. 11A. In embodiments, the switchboard system 900 is configured to generate and communicate secure communications with the issuer system, e.g., the client server 1184 and the validator 1188. At 1132, the switchboard system 900 sends a request for a key to the client server 1184. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1134, the client server 1184 generates a portion of the key. In some instances, the client server 1184 may generate half of the ECDH key for encryption/decryption of PII. Specifically, the client server 1184 may generate <CLIENT EC PUBLIC KEY> and <CLIENT EC PRIVATE KEY>using Elliptic Curve P256. The CLIENT EC PUBLIC KEY AND CLIENT EC PRIVATE KEY is the first half of the ECDH key negotiation.

At 1136, the client-server 1184 stores the generated portion of the key in storage. Specifically, the client server 1184 may store <CLIENT EC PUBLIC KEY> and <CLIENT EC PRIVATE KEY>with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1184 may return the public key portion to the switchboard system 900 with the KEY ID at 1138. The switchboard system 900 may store the public key portion with the KEY ID for later use, e.g., generation of the ECDH key. At 1140, the switchboard system 900 may request a validation to be performed by the validator 1188. In one example, the switchboard system 900 may send a request validation as Request validation <MESSAGE>, <SIGNED SESSION TOKEN>, <CLIENT EC PUBLIC KEY>, <CONSENT DATE>, and the <TOS VERSION>. The validator 1188 may make an out-of-band request back to the switchboard system 900 for the public key to verify the session at 1142. At 1144, the switchboard system 900 may provide the node's public key, i.e., <NODE PUBLIC KEY>. Further at 1146, the validator 1188 may utilize the node's public key to verify the secure session token.

In embodiments, the validator 1188 may validate the message at 1148. In embodiments, the validator 1188 may perform a number of validations including ensuring the nonce in the message is correct along with additional information, such as the card's unique identifier (pUID), and the counter value (pATC).

At 1150, the validator 1188 may store information associated with the session. For example, validator 1188 may store the <CONSENT DATE>with the <TOS VERSION> and the <PUID>. The validator 1188 may also generate another portion of the key, e.g., the ECDH key. For example, the 1188 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 1154, the validator 1188 may generate the complete ECDH key. For example, the validator 1188 generates the <ECDH KEY> from <ISSUER EC PRIVATE KEY> and <CLIENT EC PUBLIC KEY>. The ECDH KEY is the final key generated using ECDH key negotiation.

The validator 1188 may utilize the ECDH KEY to encrypt data for the function. For example, if the validator 1188 validates the message in some instances, the validator 1188 may execute a function request to create a function result and encrypt the result with the ECDH KEY at 1156. For example, the validator 1188 may Execute <FUNCTION REQUEST> to create <FUNCTION RESULT> and encrypt it with the <ECDH KEY>. The function result may be any result based on the requested function, e.g., verification of the card.

At 1158, the validator 1188 may return the function result to the switchboard system 900. In some instances, the function result is returned encrypted. For example, the validator 1188 may return the <ENCRYPTED FUNCTION RESULT> and the <ISSUER EC PUBLIC KEY>.

FIG. 11C continues the sequence 1100 from FIG. 11B. In embodiments, at 1160 the switchboard system 900 sends the function result to the client server 1184 to process the result. In one example, the switchboard system 900 may send the <ENCRYPTED FUNCTION RESULT>, <KEY ID>, <ISSUER EC PUBLIC KEY>, and <SIGNED SESSION TOKEN>. At 1162 and 1164, the client server 1184 may make a request for and receive the public key from the switchboard system 900. In some instances, the exchange may be performed via out-of-band communication channels. The public key for the node may be <NODE PUBLIC KEY>. The public key may be used to verify the sender of the function result, etc. At 1166, the client server 1184 may verify the signed session key with the node's public key <NODE PUBLIC KEY> to verify the sender of the information. At 1168, the client server 1184 may extract client information from the signed session token. For example, the client server 1184 may Extract <CLIENT SESSION INFO> from <SIGNED SESSION TOKEN>, i.e., extracting the client implementation-specific user session identification information.

Further, at 1170, the client server 1184 may retrieve the client's private key with the KEY ID. Specifically, the client server 1184 may get and remove the <CLIENT PRIVATE KEY>from cache using the <KEY ID>. At 1172, the client server 1184 may generate or compute the ECDH key. For example, the client server 1184 may compute the <ECDH KEY>with the <CLIENT PRIVATE KEY>+<ISSUER EC PUBLIC KEY>. The client server 1184 may decrypt the function result with the computed key at 1174. Specifically, the client server 1184 may decrypt the <ENCRYPTED FUNCTION RESULT>with the <ECDH KEY> to determine the <FUNCTION RESULT>. At 1176, the client server 1184 associates the function result with the session.

In embodiments, the switchboard system 908 may return whether the function result was successfully completed or not at 1178 to the client SDK 1192. Further at 1180, the client SDK 1192 may notify the client app 1190 of the result. At 1182, the client app 1190 may utilize the feature. For example, the 1182 may communicate with the client server 1184 to continue the feature using the <CLIENT SESSION INFO> to fetch the redacted <FUNCTION RESULT>.

FIG. 12 illustrates an example of a message 1200 that may be communicated by a contactless card to perform the functions described herein, such as those discussed in FIG. 11A through FIG. 11C. One or more of the fields in message 1200 may also be utilized to route the message 1200 through the switchboard system 900 and perform authentication/validation techniques. The message 1200 is an example message that may be the encrypted data or be included in the encrypted data sent by the contactless card 102 to the user device 104 during the NFC read of the contactless card 102 by the user device 104. This message 1200 is then sent to the authentication server 110 for decryption.

In embodiments, the message 1200 includes an applet version 1202 field, an issuer discretionary indicator 1204 field, an Issuer Identifier 1206 field, a pKey ID 1208 field, a pUID 1210 field, a pATC 1212 field, a nonce 1214 field, and an encrypted cryptogram 1216.

In embodiments, the fields may be in plain text or encrypted. For example, the applet version 1202 field may include an applet version in plain text. The applet version indicates which applet version is installed on a contactless card and may be used by the other systems to determine how to process the message 1200 when communicated. For example, different Applet versions require different validation logic, e.g., an older message may be routed through the issuer system to perform various operations for validation, while a newer message may be routed through the switchboard system to perform the various operations, including validation.

In embodiments, the message 1200 includes an issuer discretionary indicator 1204 field that may include issuer data and set at the time of personalization. In addition, the message 1200 includes an Issuer Identifier 1206 field that may include a unique ID assigned to the entity issuing the card, e.g., the issuer. For example, when joining the system, each issuer may be assigned a unique identifier during an onboarding operation. The issuer ID can be used by the switchboard system 908 to route a message and its contents to the appropriate services that are associated with that particular issuer.

In embodiments, the message 1200 includes a pKey ID 1208 field. In some instances, the pKey ID 1208 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs.

The message 1200 may include a pUID 1210 field, including a card unique identifier assigned to the contactless card at personalization time. The pUID 1210 field data may be a combination of alphanumeric characters used to identify each card and associated with a user uniquely.

In embodiments, the message 1200 includes a pATC 1212 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1200 is created, a new session key is derived and utilized to generate one or more portions of the message 1200. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1200 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC [2] | ATC [3] | ‘FO’ | ‘00’ | [ATC [0] | [ATC [1] | [ATC [2] | [ATC [3]] with an application key. Further, the contactless card 102 computes SKR by encrypting [ATC [2] | ATC [3] | ‘OF’ | ‘00’ | [ATC [0] ∥ [ATC [1] | [ATC [2] | [ATC [3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC [2] | ATC [3] | ‘FO’ | ‘00’ | ‘00’ | ‘00’ | ‘00’ | ‘00’] with a Data Encryption Key (DEK) or UDK. Further, the contactless card 102 computes SKR by encrypting [ATC [2]|ATC[3]|‘OF’|‘00’|‘00 |‘00’|‘00’|‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES (ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES (ASKL) [B], where DES is an encryption algorithm. The contactless card 102 computes B=[B XOR T3], and the contactless card 102 computes B=DES (ASKL) [B]. The contactless card 102 computes B=[B XOR T4], and the contactless card 102 computes B=DES (ASKL) [B]. The contactless card 102 computes B=DES-1 (ASKR) [B], where DES-1 is the reciprocal DES operation, and ASKR is a portion of the ASK, e.g., the right half. The contactless card 102 computes the cryptogram C=DES (ASKL) [B].

In embodiments, a contactless card 102 may also encipher the cryptogram to secure the data further. For example, a contactless card 102 may generate an 8-byte random number [RND] and the card computes E1=DES3 (DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3 (DESK) [B], where B is computed above. Further, the contactless card 102 generates the 16-byte enciphered payload E=[E1] | [E2].

In embodiments, a device or the contactless card 102 may decrypt the payload E by determining, receiving, or retrieving the payload E. The device computes a RND=DES3-1 (DESK) [E1]. The device determines B=DES3-1 (DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes) | Update Date Time (8 bytes) | ‘80’ | ‘00 00 00 00 00’]. For the calculations, the data may be divided into two separate portions. Specifically, the data U is broken into two blocks of 8 bytes of data, whereU=U₁∥U₂. Further, operations may be performed on U₁ and U₂.

Embodiments include applying an algorithm to the first portion (U1) of the data. In one example, a result B may be computed where B=DES (MCKL) [U₁], where DES is a Data Encryption Standard algorithm using a first portion (L) of the MAC Card Key (MCKL).

Further, an additional operation may be performed on the result B. Specifically, the result B may be exclusively or′d(XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

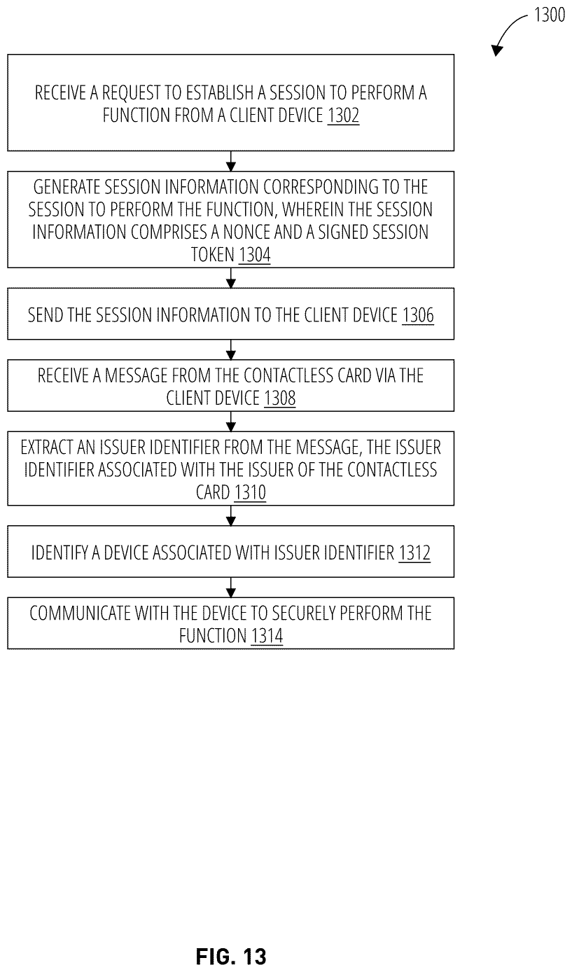

FIG. 13 illustrates an example of method 1300 in accordance with embodiments discussed herein. In block 1302, the method 1300 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1304, the method 1300 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1306, method 1300 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 12).

In block 1308, method 1300 includes receiving, by the node, a message from the contactless card via the client device. The message may be generated by the contactless card. FIG. 12 illustrates one example of a message 1200. In some embodiments, the node verifies the message. For example, the node may verify a nonce in the message and a signed session token.

In block 1310, method 1300 extracts an issuer identifier from the message by the node, the issuer identifier associated with the issuer of the contactless card. In some instances, the issuer identifier may be in a plaintext format.

In block 1312, method 1300 identifies, by the node, a device associated with the issuer identifier. For example, the node may perform a lookup to determine a server associated with the issuer identifier and the function to be performed.

In block 1314, method 1300 communicates, by the node, with the device to securely perform the function.

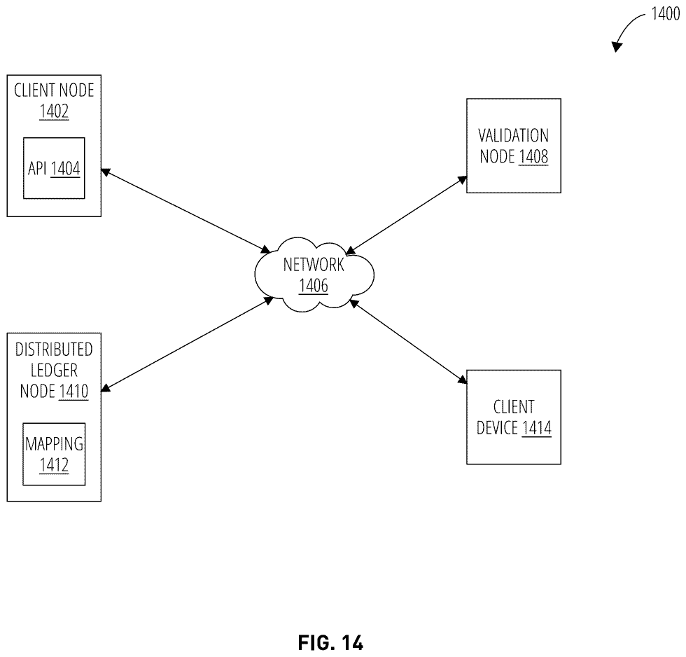

FIG. 14 illustrates a distributed network authentication system 1400 according to an example embodiment. As further discussed below, system 1400 can include client node 1402, API 1404, network 1406, distributed ledger node 1410, mapping 1412, and client device 1414. Although FIG. 14 illustrates single instances of the components, system 1400 can include any number of components.

System 1400 can include a client node 1402, which can be a network-enabled computer as described herein. In some examples, client node 1402 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, client node 1402 can execute one or more applications, such as software applications, that enable, for example, network communications with one or more components of system 1400, transmit and/or receive data, and perform the functions and processes described herein.

The client node can contain an API 1404. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1404 to interact with the service, such as by performing a remote call to an API for interacting with a web-based service.

API 1404 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1402 can communicate with one or more other components of system 1400 either directly or via network 1406. Network 1406 can comprise one or more of a wireless network, a wired network or any combination of wireless network and wired network, and may be configured to connect the components of system 1400. While FIG. 14 illustrates communication between the components of system 1400 through network 1406, it is understood that any component of system 1400 can communicate directly with another component of system 1400, e.g., without involving network 1406.

System 1400 can include a validation node 1408, which can be a network-enabled computer as described herein. In some examples, validation node 1408 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, validation node 1408 can execute one or more applications, such as software applications, that enable, for example, network communications with one or more components of system 1400, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1400 can include a distributed ledger node 1410, which can be a network-enabled computer as described herein. In some examples, distributed ledger node 1410 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, distributed ledger node 1410 can execute one or more applications, such as software applications, that enable, for example, network communications with one or more components of system 1400, transmit and/or receive data, and perform the functions and processes described herein.

Distributed ledger node 1410 can containing a mapping 1412. In some examples, mapping 1412 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1400, or the one or more databases can be hosted externally to any component of the system 1400. In some examples, the one or more databases can be contained in the distributed ledger node 1410, and in other examples the one or more databases can be stored outside of distributed edger node 1410 but in data communication with distributed ledger node 1410. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=′value′;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1410. In other examples, the one or more databases can be remote from distributed ledger node 1410 but in data communication with distributed ledger node 1410. Data communication between the one or more databases and distributed ledger node 1410 can be a direct data communication or data communication via a network, such as the network 1406.

In some examples, client node 1402 can be in data communication with distributed ledger node 1410. Distributed ledger node 1410 can contain mapping 1412. Mapping 1414 may include, e.g., a mapping between a validation node address and the validation node 1408, a mapping between a routing number and a validation node address, and/or a mapping between a routing number and validation node 1408. In some examples, mapping 1412 can include a digital signature associated with an entity having permission to validate for a routing number. Based on one or more of these associations, client node 1402 can call validation node for validation and/or provide direction to the client device to reach the appropriate validation node. This can be accomplished by calling a validation API associated with validation node 1408.

In some examples, iterations of the mappings described herein, such as mapping 1412, can also include a software or applet version number. The version number can be used to identify a validation node or validation node address or choose between multiple validation addresses for one validation node.

In some examples, client node 1402 and distributed ledger node 1410 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1410 can update mapping 1412 to reflect a different association between, e.g., a routing number, a validation node address, and a validation node. In some examples, degrees of permissions can be issued. For example, if client node 1402 were to function to route data to validation node 1408 (or other validation nodes), client node 1402 can be given a certain level of permissions. As another example, if distributed ledger node 1410 were to have the capability to update mapping 1412, distributed ledger node 1410 can have a different, higher level of permissions.

System 1400 can include a client device 1414, which can be a network-enabled computer as described herein. In some examples, distributed ledger node 1414 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400. Client device 1414 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1414 can be in data communication with another network-enabled computer not shown in FIG. 14, such as a smart card (e.g., a contactless card or a contact-based card).

In some examples, client device 1414 can execute one or more applications, such as software applications, that enable, for example, network communications with one or more components of system 1400, transmit and/or receive data, and perform the functions and processes described herein.

In some examples, upon receipt of an authentication request, client device 1414 can call (e.g., via an API) client node 1402. The call can include a routing number and/or an applet or software version number, and client node 1402 can query distributed ledger node 1410 and mapping 1412. Once the query returns the identification of a validation node (e.g., validation node 1408) and/or a validation node address associated with that routing number and/or applet or software version, client node 1402 can reply to client device 1414. Client device 1414 can then proceed with authentication with the validation node. The authentication can be performed by, e.g., the systems and methods described herein, such as by the generation, encryption, transmission, decryption, and validation of a cryptogram as described herein.

In some examples, client node 1402 can be co-resident with validation node 1408. In these examples, client node 1402 can handle the authentication in a single call from client device 1414. In some examples, this can be acceptable only if it is permissible for the full authentication transmission (e.g., a cryptogram as described herein) to be sent to client nodes that are not involved in authentication.

In some examples, if client node 1402 receives, from client device 1414, a routing number that is not handled by its location, client node 1402 can return a code indicating that this routing number is not handled, along with validation node address for the responsible validation node. Client device 1414 can then send the full authentication transmission to validation node 1408 using the received validation node address.

In some examples, client node 1402 can enter the distributed network with different permissions. For example, client node 1402 can be a read-only router of data. As another example, client node 1402 can have permission to send messages to distributed ledger node 1410 updating one or more routing paths for one or more routing numbers. However, client node 1402 would be prevented from updating one or more routing paths for one or more routing numbers for other entities that control other routing numbers which are not associated with client node 1402 or that did not grant this permission. As another example, distributed ledger node 1410 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1402, distributed ledger node 1410, and/or validation node 1408, if security, legal, and/or financial conditions are met, however, delegation is not required.

In some examples, one or more APIs can facilitate communication between components of system 1400 via network 1406. In other examples, one or more APIs are not required. Rather, the components of system 1400 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1408 for authentication, can require storage of the keys in one or more HSMs, to promote key security and ensure that the keys are never entered into memory.

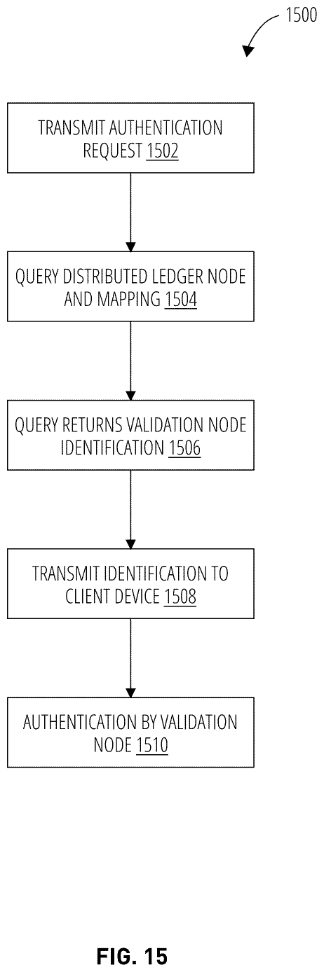

FIG. 15 illustrates a method 1500 performed by a distributed network authentication system according to an example embodiment. For example, the method can be performed by distributed network authentication system 1400 and or by another distributed network authentication system.

In block 1502, a client device can transmit an authentication request to a client node. The authentication request can include, without limitation, a routing number, a software version number, and/or an applet version number. The request can be made by an API call or other communication between the client device and the client node.

In block 1504, after receiving the authentication request, the client node can transmit a query (e.g., via an API call) to a distributed ledger node. The distributed ledger node contain a mapping, and the distributed ledger node can submit the query to the mapping.

In block 1506, the query can return an identification of a validation node and/or a validation node address, and the distributed ledger node can transmit this identification to the client node.

In block 1508, the client node can transmit the identification to the client device. After receiving the identification, the client device can proceed with authentication with the identified validation node and/or validation node address, in block 1510.

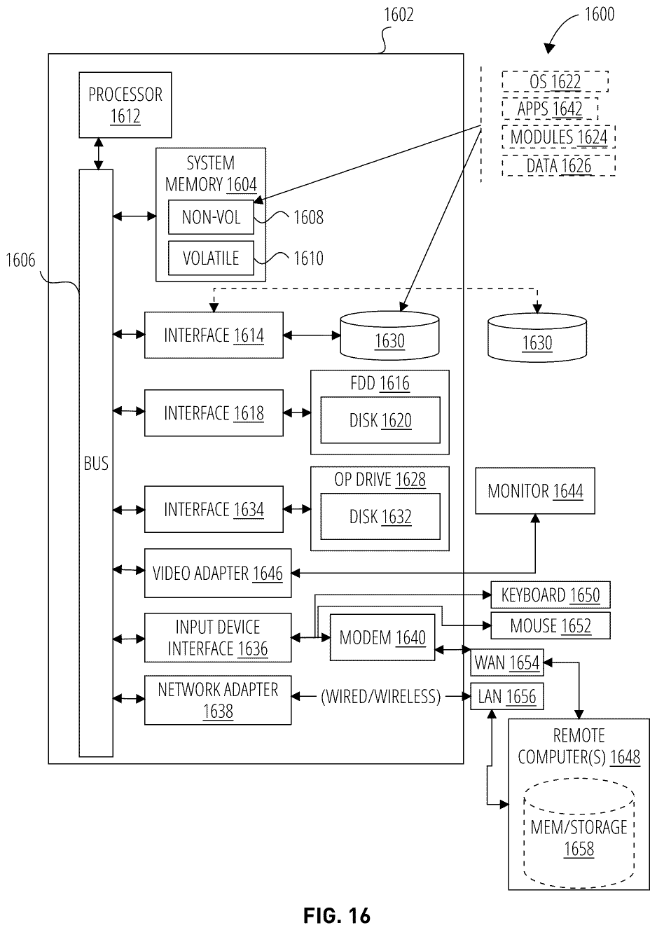

FIG. 16 illustrates an embodiment of an exemplary computer architecture 1600 suitable for implementing various embodiments as previously described. In one embodiment, the computer architecture 1600 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing computer architecture 1600 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 1600.

As shown in FIG. 16, the computing computer architecture 1600 includes a processor 1612, a system memory 1604 and a system bus 1606. The processor 1612 can be any of various commercially available processors or processor circuits.

The system bus 1606 provides an interface for system components including, but not limited to, the system memory 1604 to the processor 1612. The system bus 1606 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1600 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1604 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 16, the system memory 1604 can include non-volatile 1608 and/or volatile 1610. A basic input/output system (BIOS) can be stored in the non-volatile 1608.

The computer 1602 may include various types of computer-readable storage media in the form of one or more lower speed memory units, including an internal (or external) hard disk drive 1630, a magnetic disk drive 1616 to read from or write to a removable magnetic disk 1620, and an optical disk drive 1628 to read from or write to a removable optical disk 1632 (e.g., a CD-ROM or DVD). The hard disk drive 1630, magnetic disk drive 1616 and optical disk drive 1628 can be connected to system bus 1606 the by an HDD interface 1614, and FDD interface 1618 and an optical disk drive interface 1634, respectively. The HDD interface 1614 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1608, and volatile 1610, including an operating system 1622, one or more applications 1642, other program modules 1624, and program data 1626. In one embodiment, the one or more applications 1642, other program modules 1624, and program data 1626 can include, for example, the various applications and/or components of the systems discussed herein.

A user can enter commands and information into the computer 1602 through one or more wire/wireless input devices, for example, a keyboard 1650 and a pointing device, such as a mouse 1652. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1612 through an input device interface 1636 that is coupled to the system bus 1606 but can be connected by other interfaces such as a parallel port, IEEE 1394 serial port, a game port, a USB port, an IR interface, and so forth.

A monitor 1644 or other type of display device is also connected to the system bus 1606 via an interface, such as a video adapter 1646. The monitor 1644 may be internal or external to the computer 1602. In addition to the monitor 1644, a computer typically includes other peripheral output devices, such as speakers, printers, and so forth.

The computer 1602 may operate in a networked environment using logical connections via wire and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all the elements described relative to the computer 1602, although, for purposes of brevity, only a memory and/or storage device 1658 is illustrated. The logical connections depicted include wire/wireless connectivity to a local area network 1656 (LAN) and/or larger networks, for example, a wide area network 1654 (WAN). Such LAN and WAN networking environments are commonplace in offices and companies, and facilitate enterprise-wide computer networks, such as intranets, all of which may connect to a global communications network, for example, the Internet.

When used in a local area network 1656 networking environment, the computer 1602 is connected to the local area network 1656 through a wire and/or wireless communication network interface or network adapter 1638. The network adapter 1638 can facilitate wire and/or wireless communications to the local area network 1656, which may also include a wireless access point disposed thereon for communicating with the wireless functionality of the network adapter 1638.

When used in a wide area network 1654 networking environment, the computer 1602 can include a modem 1640, or is connected to a communications server on the wide area network 1654 or has other means for establishing communications over the wide area network 1654, such as by way of the Internet. The modem 1640, which can be internal or external and a wire and/or wireless device, connects to the system bus 1606 via the input device interface 1636. In a networked environment, program modules depicted relative to the computer 1602, or portions thereof, can be stored in the remote memory and/or storage device 1658. It will be appreciated that the network connections shown are exemplary and other means of establishing a communications link between the computers can be used.

The computer 1602 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-16 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
receiving, at a server associated with a website, a request from a user account to register, with the website, a Fast Identity Online (FIDO) key associated with the user account;
in response to receiving the request, causing, by the server, a program on a device associated with the user account to be initiated, the program to permit the device to receive encrypted data from a contactless card associated with the user account and to send the encrypted data to an authentication server to validate an identity of the user account; and
in response to receiving, by the server associated with the website from the authentication server, a first message indicating that the identity of the user account that sent the request has been validated, granting the request from the user account and registering the FIDO key associated with the user account with the website.

2. The method of claim 1, further comprising:
in response to receiving, by the server associated with the website from the authentication server, a second message indicating that the identity of the user account that sent the request is not validated, denying the request from the user account to register the FIDO key.

3. The method of claim 1, wherein:
the request from the user account includes an indication to the server associated with the website, that the user account has a contactless card associated therewith; and
causing, by the server, the program on the device to be initiated including, causing an element to be displayed on a browser associated with the user account, whereby upon interacting with the element, the device is caused to initiate the program, the program allowing the device to receive the encrypted data from the contactless card via near field communication (NFC), radio frequency identification (RFID), Wi-Fi, or Bluetooth®.

4. The method of claim 3, wherein the device is a mobile device; and
wherein the element includes a universal resource locator (URL) or a mobile notification.

5. The method of claim 1, wherein the user account includes an email address or phone number associated therewith and the request sent from the user account includes the email address or phone number.

6. The method of claim 5, further comprising:
sending, by the server associated with the website, a third message to a card issuer server of the contactless card requesting confirmation that the email address or phone number from the request is also associated with the user account and the contactless card.

7. The method of claim 6, further comprising:
receiving a reply to the third message from the card issuer server;
in response to the reply from the card issuer indicating that the email address or phone number associated with the user account is also associated with the contactless card, granting the request from the user account and registering the FIDO key; and
in response to the reply from the card issuer indicating that the email address or phone number associated with the user account is not also associated with the contactless card, denying the request from the user account and not registering the FIDO key.

8. The method of claim 5, wherein causing, by the server, the program on the device to be initiated includes:
sending a communication to the email address or phone number associated with the user account, the communication including a link selectable on a user interface of the device to cause initiation of the program on the device, the program allowing the device to receive the encrypted data from the contactless card via near field communication (NFC), radio frequency identification (RFID), Wi-Fi, or Bluetooth®.

9. A method, comprising:
receiving, at a server associated with a website, a request from a user account to register, with the website, a Fast Identity Online (FIDO) key associated with the user account, the request including a selected second factor authentication mode and a user identifier associated with the user account;
in response to receiving the request, sending a prompt to a mobile device associated with the user account and the user identifier, the prompt including a prompt to perform second factor authentication of the user account with an authentication server, where performing the second factor authentication of the user account includes using a contactless card associated with the user account in a manner corresponding to the selected second factor authentication mode; and
in response to receiving, by the server associated with the website from the authentication server, a first message indicating that an identity of the user account that sent the request has been authenticated, granting the request from the user account and registering the FIDO key associated with the user account with the website.

10. The method of claim 9, further comprising:
in response to receiving, by the server from the authentication server, a second message indicating that the identity of the user account that sent the request is not authenticated, denying the request from the user account to register the FIDO key.

11. The method of claim 9, wherein the selected second factor authentication mode includes authentication using a Europay, MasterCard, and Visa (EMV) authentication method, authentication using encrypted data from the contactless card routed to the authentication server, or a FIDO authentication method.

12. The method of claim 9, wherein the user identifier includes an email address, telephone number, or social media handle associated with the user account.

13. The method of claim 9, wherein the request further includes an indication from the user account that the user account has the contactless card associated therewith, the contactless card configured to perform the second factor authentication of the user account.

14. An apparatus associated with a website, the apparatus comprising:
a memory storing executable instructions thereon; and
a processing circuit to execute the executable instructions, which when executed by the processing circuit, causes the apparatus to:
receive a request from a computing device associated with a user account to register, with the website, a Fast Identity Online (FIDO) key associated with the user account;
in response to receiving the request, send the computing device a message including an element for display on a web browser of the computing device, the element to be interacted with by a user of the computing device, wherein upon interacting with the element, a software application on a mobile device of a user associated with the user account is executed, the software application to permit the mobile device of the user to receive encrypted data from a contactless card associated with the user account and to send the encrypted data to an authentication server to validate an identity of the user account; and
in response to receiving, from the authentication server, an authentication response indicating that the identity of the user account associated with the mobile device has been validated, grant the request from the computing device and register the FIDO key associated with the user account with the website.

15. The apparatus of claim 14, further comprising:
in response to receiving, from the authentication server, an authentication message indicating that the identity of the user account that sent the request is not validated, deny the request from the user account to register the FIDO key.

16. The apparatus of claim 14, wherein the computing device is a desktop computer, workstation, personal computer, server, or cloud device.

17. The apparatus of claim 14, wherein the element for display includes a quick response (QR) code; and
wherein interacting with the QR code includes using the mobile device to scan the QR code, which causes the software application to be executed on the mobile device to thereby receive the encrypted data from the contactless card.

18. The apparatus of claim of claim 14, wherein the element for display includes a universal resource locator (URL) link to be interacted with by the user; and
wherein interacting with the URL includes the processing circuit to send the URL to the mobile device for the user to select the URL, which causes the software application to be executed on the mobile device to thereby receive the encrypted data from the contactless card.

19. The apparatus of claim 14, wherein the processing circuit is further caused to generate a session ID associated with the request and send the session ID with the message to the computing device, the session ID to be sent to the mobile device when the mobile device interacts with the element, and the mobile device is to send the session ID to the authentication server.

20. The apparatus of claim 14, wherein the authentication response from the authentication server includes the session ID to indicate to the apparatus which user account is being authenticated.
